(19) United States
(12) Patent Application Publication
(10) Pub. No.: US 2026/0255432 A1
(43) Pub. Date: Aug. 27, 2026

(54) COMMUNICATION METHOD, USER EQUIPMENT, AND NETWORK NODE

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/647,697

(22) Filed: Apr. 14, 2026

Related U.S. Application Data
(63) Continuation of application No. PCT/JP2024/036711, filed on Oct. 15, 2024.

(30) Foreign Application Priority Data
Oct. 16, 2023 (JP) 2023-178498

(51) Int. Cl. H04W 76/27; H04W 24/10; H04W 76/40

(52) U.S. Cl. CPC H04W 76/27; H04W 24/10; H04W 76/40

(57) ABSTRACT

A communication method executed in a mobile communication system for providing an MBS includes: starting, by a user equipment in an RRC inactive state, RRC connection resume in association with a multicast session that the user equipment has already joined; starting, by the user equipment, measurement relating to the RRC connection resume at a first timing at which a start event for the RRC connection resume has occurred; ending, by the user equipment, the measurement at a second timing at which an end event for the RRC connection resume has occurred; and by the user equipment, storing log information indicating a result of the measurement and then transmitting the log information to a network.

### RELATED APPLICATIONS

The present application is a continuation based on PCT Application No. PCT/JP2024/036711, filed on Oct. 15, 2024, which claims the benefit of Japanese Patent Application No. 2023-178498 filed on Oct. 16, 2023. The content of which is incorporated by reference herein in their entirety.

### TECHNICAL FIELD

The present disclosure relates to a communication method, a user equipment, and a network node used in a mobile communication system.

### BACKGROUND

The 3rd Generation Partnership Project (3GPP) (trademark, the same applies to the following descriptions) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a Radio Resource Control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1: 3GPP Technical Specification: TS 38.300 V 17.5.0

### SUMMARY

The present disclosure provides a communication method, a user equipment, and a network node that facilitate network optimization relating to multicast reception in a Radio Resource Control (RRC) inactive state.

In a first aspect, a communication method is a communication method executed in a mobile communication system for providing a Multicast Broadcast Service (MBS), and includes: starting, by a user equipment in a Radio Resource Control (RRC) inactive state, RRC connection resume in association with a multicast session that the user equipment has already joined; starting, by the user equipment, measurement relating to the RRC connection resume at a first timing at which a start event for the RRC connection resume has occurred; ending, by the user equipment, the measurement at a second timing at which an end event for the RRC connection resume has occurred; and by the user equipment, storing log information indicating a result of the measurement and then transmitting the log information to a network.

In a second aspect, a user equipment is a user equipment used in a mobile communication system for providing a Multicast Broadcast Service (MBS), and includes: a controller configured to execute processing of starting, in a Radio Resource Control (RRC) inactive state, RRC connection resume in association with a multicast session that the user equipment has already joined, processing of starting measurement relating to the RRC connection resume at a first timing at which a start event for the RRC connection resume has occurred, processing of ending the measurement at a second timing at which an end event for the RRC connection resume has occurred, and processing of storing log information indicating a result of the measurement and then transmitting the log information to a network.

In a third aspect, a network node is a network node used in a mobile communication system for providing a Multicast Broadcast Service (MBS), and includes a controller configured to acquire, from a user equipment, log information indicating a result of measurement relating to RRC connection resume from a first timing at which a start event for the RRC connection resume associated with a multicast session that the user equipment has already joined has occurred to a second timing at which an end event for the RRC connection resume has occurred.

### BRIEF DESCRIPTION OF THE DRAWINGS

FIG. 1 is a diagram illustrating a configuration example of a mobile communication system according to an embodiment.

FIG. 2 is a diagram illustrating a configuration example of a UE (user equipment) according to the embodiment.

FIG. 3 is a diagram illustrating a configuration example of a gNB (network node) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of an operation of the UE according to the embodiment.

FIG. 7 is a diagram illustrating an example of a first operation pattern according to the embodiment.

FIG. 8 is a diagram illustrating another example of the first operation pattern according to the embodiment.

FIG. 9 is a diagram illustrating an example of a second operation pattern according to the embodiment.

FIG. 10 is a diagram illustrating another example of the second operation pattern according to the embodiment.

### DESCRIPTION OF EMBODIMENTS

According to an embodiment, a mobile communication system is described with reference to the drawings. In the description of the drawings, the same or similar parts are denoted by the same or similar reference signs.

### (1) System Configuration Example

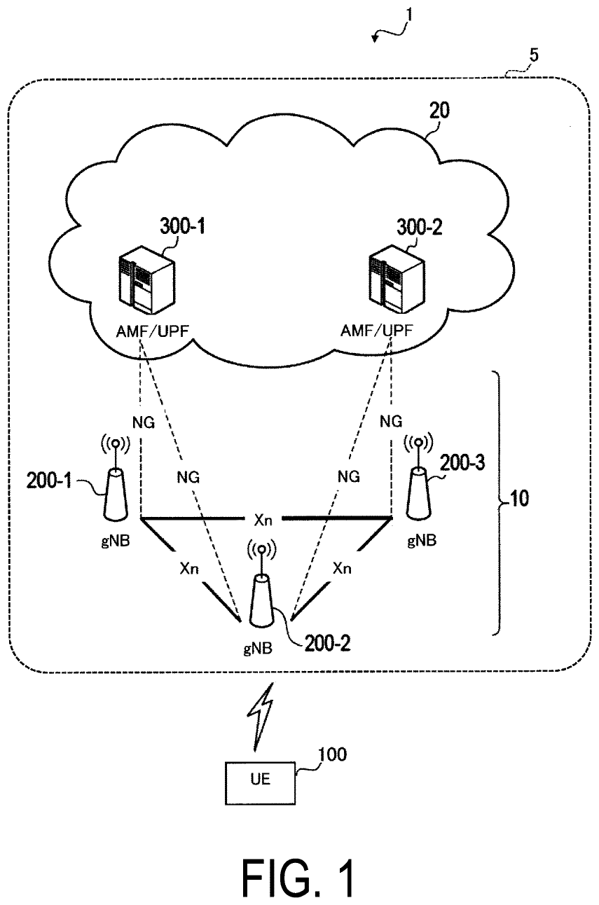

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in 5G systems) 200, which are a type of network node. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a Radio Resource Management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can also be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

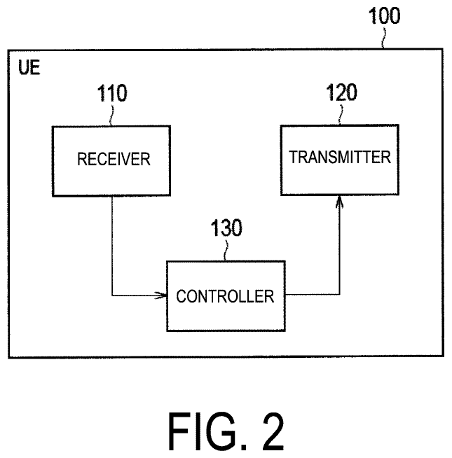

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal received through the antenna into a baseband signal (a reception signal), and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various controls and processes in the UE 100. Such processing includes processing of respective layers to be described later. The operations of the UE 100 described above and below may be operations under the control of the controller 230. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

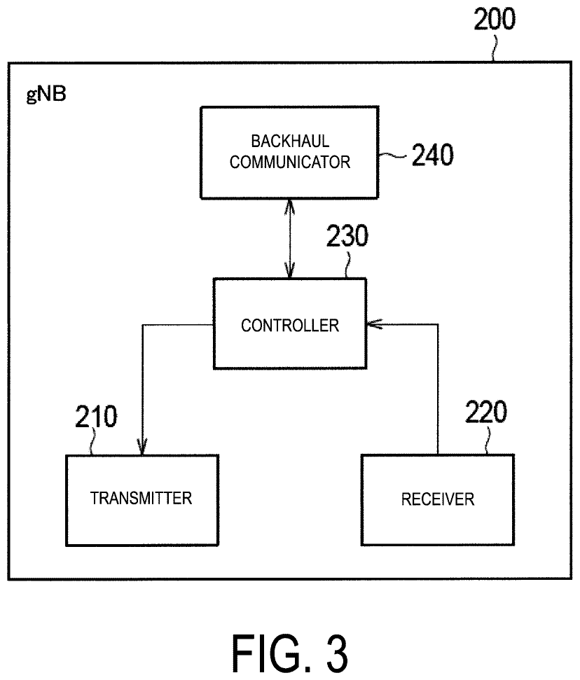

FIG. 3 is a diagram illustrating a configuration example of the gNB 200 (network node) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal, and transmits the resulting signal through the antenna.

The receiver 220 performs various types of reception under control of the controller 230. The receiver 220 includes an antenna and a reception device. The reception device converts a radio signal received through the antenna into a baseband signal (a reception signal), and outputs the resulting signal to the controller 230.

The controller 230 performs various types of control and processing in the gNB 200. Such processing includes processing of respective layers to be described later. The operations of the gNB 200 described above and below may be also operations under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

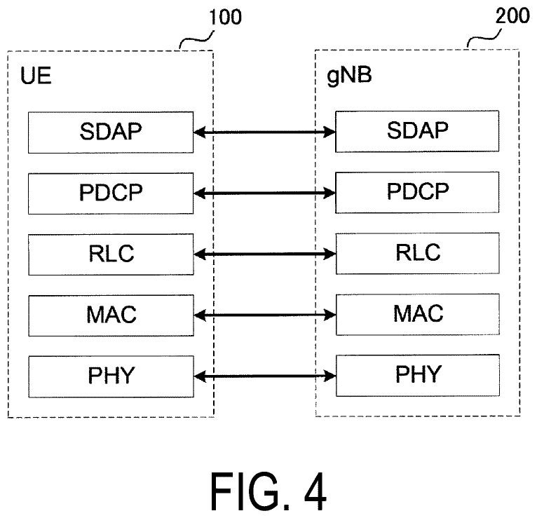

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). Specifically, the UE 100 performs blind decoding of the PDCCH by using a Radio Network Temporary Identifier (RNTI) and acquires a successfully decoded DCI as a DCI addressed to the UE. The DCI transmitted from the gNB 200 is appended with Cyclic Redundancy Code (CRC) parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes and Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

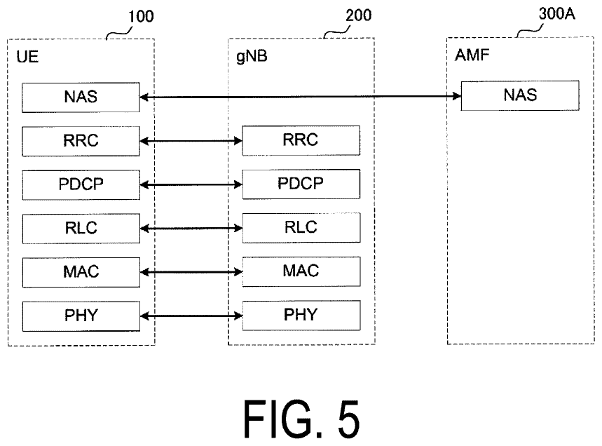

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as a “NAS”), which is located above the RRC layer, performs session management, mobility management, and the like. NAS signaling is transmitted between the NAS layer of the UE 100 and the NAS layer of an AMF 300A. Note that the UE 100 includes an application layer other than the protocol of the radio interface. The layer below the NAS layer is referred to as an AS layer (also simply referred to as an “AS”).

### (2) Overview of MBS

The mobile communication system 1 can perform delivery with high resource efficiency by using the Multicast/Broadcast Service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of MBS session. The UE 100 can receive the broadcast session in any state of the RRC idle state, the RRC inactive state, and the RRC connected state.

Point-to-Multipoint (PTM) delivery is applied to the broadcast communication service. For the PTM transmission, the gNB 200 delivers a single copy of an MBS packet to a set (group) of a plurality of the UEs 100. For example, the gNB 200 uses a group-common PDCCH with a CRC scrambled by a Group RNTI (G-RNTI) that is a group-common RNTI to schedule a group-common PDSCH scrambled by the G-RNTI.

For the broadcast communication service, the UE 100 receives a broadcast session in the following procedure. First, the UE 100 receives system information block type 20 (SIB 20) from the gNB 200. The SIB 20 includes a configuration of a Multicast Control CHannel (MCCH), which is a type of logical channel. Second, the UE 100 receives the MCCH from the gNB 200 based on the SIB 20. The MCCH includes a PTM configuration. The PTM configuration transmits a configuration for a Multicast Traffic CHannel (MTCH) (MTCH configuration), which is a type of logical channel, and a configuration of a broadcast Multicast Radio Bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting the MBS broadcast control information associated with one or more MTCHs from the network 5 to the UE 100. The MTCH is a PTM downlink channel for transmitting MBS data of a multicast session or a broadcast session from the network 5 to the UE 100.

### (2.2) MBS Multicast

For a multicast communication service (also referred to as “MBS multicast”), the same service and the same specific content data are simultaneously provided to a specific UE set. That is, not every UE 100 in the multicast service area is permitted to receive data. The multicast communication service is delivered to the UE 100 using a multicast session that is a type of MBS session.

The UE 100 can receive a multicast session only after joining the multicast session (session join). The joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, enhancement will be made such that the UE 100 in the RRC inactive state also can receive a multicast session.

### (2.2.1) Multicast Reception in RRC Connected State

The UE 100 in the RRC connected state can receive a multicast session (specifically, MBS data belonging to a multicast session) by using mechanisms such as Point-to-Point (PTP) delivery and/or Point-to-Multipoint (PTM) delivery.

For the multicast communication service, the UE 100 in the RRC connected state receives a multicast session in the following procedure. First, the UE 100 receives an RRC Reconfiguration message from the gNB 200. The RRC Reconfiguration message is a message transmitted on a Dedicated Control CHannel (DCCH). The RRC Reconfiguration message transmits a configuration for an MTCH for multicast session reception (MTCH configuration) and a configuration of a multicast MRB which is an MRB for multicast session. Second, the UE 100 receives an MTCH based on the RRC Reconfiguration message. The MTCH transmits a multicast session (specifically, MBS data belonging to the multicast session).

### (2.2.2) Multicast Reception in RRC Inactive State

The UE 100 in the RRC inactive state can receive a multicast session (specifically, MBS data belonging to the multicast session) by using the mechanism of the PTM delivery.

For the multicast communication service, the UE 100 in the RRC inactive state can receive a multicast session in the following procedure. First, the UE 100 in the RRC inactive state receives a newly introduced system information block (also referred to as an “SIBx”) from the gNB 200. The SIBx includes a configuration of a newly introduced MCCH (also referred to as a “multicast MCCH”). Second, the UE 100 in the RRC inactive state receives a multicast MCCH based on the SIBx from the gNB 200. The multicast MCCH includes a PTM configuration. The PTM configuration transmits a configuration relating to an MTCH for multicast session reception (MTCH configuration), and a configuration of a multicast inactive MRB that is an MRB for multicast session reception in the RRC inactive state (multicast inactive MRB configuration). The MTCH configuration may be included in the multicast inactive MRB configuration. Third, the UE 100 in the RRC inactive state receives an MTCH based on the multicast MCCH. The MTCH transmits a multicast session, specifically, MBS data belonging to the multicast session (i.e., multicast data).

When configuring the UE 100 to receive the multicast session in the RRC inactive state, the gNB 200 can transmit to the UE 100 the PTM configuration (multicast inactive MRB configuration) using an RRC release message including a suspend configuration. In this case, upon receiving the RRC Release message including the PTM configuration from the gNB 200, the UE 100 transitions to the RRC inactive state and receives the multicast session in the RRC inactive state (multicast reception).

### (2.2.3) Group Notification

When there temporarily exists no data to transmit to the UE 100 in the activated multicast session, the gNB 200 may cause the UE 100 to transition to the RRC inactive state. When the multicast session is deactivated, the gNB 200 may cause the UE 100 to transition to the RRC idle state or the RRC inactive state.

The gNB 200 supporting the MBS notifies the UE 100 in the RRC idle state or the RRC inactive state by using a group notification mechanism when the multicast session is activated by the CN 20. For example, the gNB 200 that supports MBS may perform a notification to the UE 100 in the RRC inactive state using a group notification mechanism when a multicast session has been activated and the gNB 200 has multicast session data to deliver.

Upon receiving the group notification, the UE 100 reconnects to the network 5 or resumes the connection to transition to the RRC connected state. The group notification is processed with a paging RNTI (P-RNTI) on the PDCCH, and a paging channel is monitored by the UE 100.

A paging message for the group notification includes session identifiers (MBS session IDs) used for paging all the UEs 100 that are in the RRC idle state and the RRC inactive state and have joined the associated MBS multicast session. That is, the UE 100 is not individually paged.

When the UE 100 transitions to the RRC connected state, the UE 100 may stop monitoring the group notification associated with the particular multicast session. That is, the UE 100 stops checking the MBS session ID in the paging message. The UE 100 does not monitor the group notification in a case where the UE 100 leaves the multicast session, the network 5 requests the UE 100 to leave the multicast session, or the network 5 releases the multicast session.

Note that the group notification may be performed on the MCCH or may be performed with an MCCH Change Notification. In the case of using the MCCH, the determination may be made depending on whether the MTCH configuration of the MBS session of interest is present in the MCCH. In a case of using the MCCH Change Notification, the group notification may be made in a predetermined bit of the DCI.

### (3) Operation of Mobile Communication System

An operation of the mobile communication system 1 according to the embodiment will be described.

### (3.1) Overview of Operation

In the embodiment, a scenario that the UE 100 in the RRC inactive state starts RRC connection resume (also referred to as “RRC resume” or a “RRC connection resume procedure”) in association with a multicast session (multicast reception) that the UE 100 has already joined is assumed. Here, examples of a case where the UE 100 in the RRC inactive state starts the RRC connection resume in association with the multicast session include a case where reception quality at a time of multicast reception in the UE 100 has deteriorated and/or a case where necessity for the UE 100 to acquire from the network 5 (gNB 200) a multicast reception configuration (PTM configuration) for receiving the multicast session has arisen. For example, the UE 100 starts the RRC connection resume in response to poor reception quality at the time of multicast reception in the RRC inactive state. The UE 100 in the RRC inactive state may start the RRC connection resume in response to a rise of the necessity to acquire the multicast reception configuration from the gNB 200.

The case where the reception quality at the time of multicast reception in the UE 100 has deteriorated is a case where Reference Signal Received Power (RSRP) measured by the UE 100 for a serving cell falls below a RSRP threshold value configured by the network 5 for the UE 100 and/or a case where the Reference Signal Received Quality (RSRQ) measured by the UE 100 for the serving cell falls below the RSRQ threshold value configured by the network 5 for the UE 100. In this regard, the case where the reception quality at the time of multicast reception in the UE 100 has deteriorated may be a case where a Bit Error Rate (BER) measured by the UE 100 for the multicast session exceeds a BER threshold value configured by the network 5 for the UE 100 and/or a case where a BLock Error Rate (BLER) measured by the UE 100 for the multicast session exceeds a BLER threshold value configured by the network 5 for the UE 100. The threshold value to be compared with such reception quality at the time of multicast reception may be configured by the PTM configuration (multicast reception configuration) in MBS session units from the network 5 (gNB 200) to the UE 100 using an RRC Release message or a multicast MCCH (multicast MCCH message). For example, the UE 100 that performs multicast reception in the RRC inactive state starts the RRC connection resume procedure when the reception quality of the serving cell is worse than a threshold value configured by the network 5.

The case where the necessity for the UE 100 to acquire the multicast reception configuration from the gNB 200 has arisen may be a case where the UE 100 does not receive in the RRC Release message the multicast reception configuration of the multicast session that the UE 100 has already joined, and the serving cell does not provide the multicast reception configuration through the multicast MCCH, and where the UE 100 receives a paging message (group notification) indicating activation of the multicast session from the serving cell. The case where the necessity for the UE 100 to acquire the multicast reception configuration from the gNB 200 has arisen may be a case where the UE 100 has performed cell reselection from the first cell to the second cell and where a second cell (the reselected cell) does not provide through the multicast MCCH the multicast reception configuration of the multicast session that the UE 100 has already joined.

When the UE 100 starts the RRC connection resume in association with the multicast reception and the network 5 (gNB 200) is congested, the RRC connection resume may be rejected by the gNB 200. Here, when the UE 100 starts the RRC connection resume due to deterioration of the reception quality at the time of the multicast reception, or when the UE 100 starts the RRC connection resume due to a rise of the necessity to acquire the multicast reception configuration from the gNB 200, if the RRC connection resume is rejected by the gNB 200, the UE 100 cannot normally perform reception of multicast data (MTCH reception). Accordingly, there exists a problem in that, while service quality of an MBS lowers, the network 5 (gNB 200) has difficulty in recognizing such a decrease in the service quality of the MBS. If the network 5 (gNB 200) can recognize such a decrease in the service quality of the MBS, network optimization for suppressing the decrease in the service quality of the MBS can be performed.

Even when the RRC connection resume succeeds without being rejected, and when a long time is required from start of the RRC connection resume to success (completion) of the RRC connection resume, for example, when contention occurs in a random access procedure and/or transmission of the RRC Resume Request message is retried several times, an interruption time of the MTCH reception may be long. Accordingly, there exists also a problem in that, while service quality of an MBS lowers, the network 5 (gNB 200) has difficulty in recognizing such a decrease in the service quality of the MBS. If the network 5 (gNB 200) can recognize such a decrease in the service quality of the MBS, network optimization for suppressing the decrease in the service quality of the MBS can be performed.

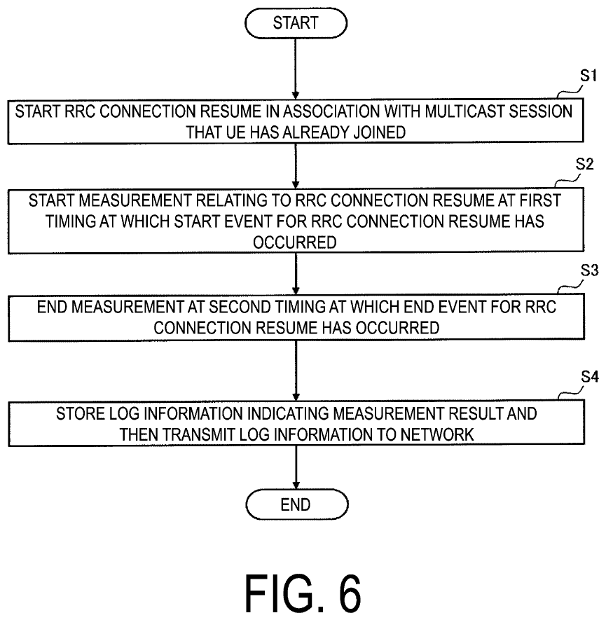

In the following embodiment, an operation for facilitating network optimization relating to multicast reception in the RRC inactive state will be described. FIG. 6 is a diagram illustrating an overview of the operation of the UE 100 according to the embodiment.

In step S1, the UE 100 in the RRC inactive state starts RRC connection resume in association with the multicast session that the UE 100 has already joined (also referred to as “RRC connection resume associated with multicast reception”).

In step S2, the UE 100 starts measurement relating to RRC connection resume at a first timing at which a start event for the RRC connection resume associated with multicast reception has occurred. Details of measurement contents will be described below. Note that step S2 may be performed simultaneously with step S1. Step S2 may be performed before step S1.

In step S3, the UE 100 ends measurement at a second timing at which an end event for RRC connection resume associated with multicast reception has occurred.

In step S4, the UE 100 stores log information indicating a result of the measurement and then transmits the log information to the network 5. Thus, the network 5 (gNB 200) can acquire (collect) the log information from the UE 100.

As described above, in the embodiment, the UE 100 performs measurement relating to the RRC connection resume from the start event to the end event for the RRC connection resume associated with the multicast reception, and transmits the log information indicating a result of the measurement to the network 5. Thus, the network 5 can recognize a decrease in the service quality of the MBS based on the log information, and can perform network optimization for suppressing the decrease in the service quality of the MBS.

According to a first operation pattern of the embodiment, the start event for the RRC connection resume associated with the multicast reception is the first event indicating that reception quality from the network 5 at the time of multicast reception has deteriorated. The UE 100 starts measurement relating to RRC connection resume at the first timing at which the start event (first event) has occurred. For example, the first event may indicate that a measurement result of the reception quality has deteriorated compared to the threshold value. The threshold value may be configured by the multicast reception configuration in the MBS session units from the network 5 (gNB 200) to the UE 100 by the RRC Release message or the multicast MCCH. The first event may indicate that a reception error of multicast reception has occurred or that the reception error has continued for a predetermined time. The predetermined time may be configured by the multicast reception configuration in the MBS session units from the network 5 (gNB 200) to the UE 100 by the RRC Release message or the multicast MCCH.

According to a second operation pattern of the embodiment, the start event for the RRC connection resume associated with the multicast reception is the second event indicating that necessity to acquire from the network 5 the multicast reception configuration for receiving the multicast session that the UE 100 has already joined has arisen. The UE 100 starts measurement relating to the RRC connection resume at the first timing at which the start event (second event) has occurred. For example, the second event may indicate that the UE 100 does not have the multicast reception configuration, and the UE 100 receives from the network 5 a group notification indicating activation of a multicast session that the UE 100 has already joined. The second event may indicate that the UE 100 has performed cell reselection from the first cell to the second cell, and the second cell does not provide, through the multicast MCCH, the multicast reception configuration for receiving the multicast session that the UE 100 has already joined.

In one embodiment, the end event is an event indicating that an RRC Resume Request message or an RRC Resume Complete message has been transmitted from the UE 100 to the network 5. The UE 100 ends the measurement relating to the RRC connection resume at the second timing at which the end event has occurred.

In the one embodiment, the end event is an event indicating that the UE 100 has received an RRC Resume message, an RRC Setup message, an RRC Release message, or an RRC Reject message from the network 5. The UE 100 ends the measurement relating to the RRC connection resume at the second timing at which the end event has occurred.

In the one embodiment, the end event is an event indicating that the UE 100 has received from the network 5 an RRC Reconfiguration message including a multicast reception configuration for receiving a multicast session after the UE 100 has transitioned to the RRC connected state, or an event indicating that the UE 100 has started receiving multicast data using the multicast reception configuration.

In the one embodiment, the UE 100 includes, in the log information, information indicating an elapsed time from the first timing to the second timing (also referred to as “elapsed time information”). For example, by starting a timer at the first timing, and stopping the timer at a second timing, the UE 100 measures a value of the timer as the elapsed time. By generating respective time stamps of the first timing and the second timing, the UE 100 may measure a difference between these two time stamps as the elapsed time. The UE 100 may include these two time stamps as the elapsed time information in the log information.

Thus, the network 5 can recognize how long it took from the start event to the end event for the RRC connection resume based on the log information (elapsed time information). Accordingly, for example, when deciding that the time is too long, the network 5 can perform network optimization for reducing the time.

In the one embodiment, the UE 100 includes, in the log information, information (also referred to as “packet error information”) indicating a packet error count or a packet error rate of multicast reception from the first timing to the second timing. The UE 100 may monitor a reception status of packets (e.g., PDCP packets) carrying MBS data, and measure the packet error count or the packet error rate by specifying missing packets based on, for example, sequence numbers of the packets.

Thus, the network 5 can recognize how many packet errors have occurred from the start event to the end event for the RRC connection resume based on the log information (packet error information). Accordingly, when, for example, deciding that there exist too many packet errors, the network 5 can perform network optimization for reducing the packet errors.

In the one embodiment, the UE 100 includes, in the log information, information relating to whether the RRC connection resume associated with the multicast reception has succeeded (also referred to as “resume result information”). The success of the RRC connection resume may mean that the UE 100 has transitioned to the RRC connected state. The resume result information may be information on the number of times indicating which RRC resume has succeeded. The resume result information may be information on the number of times indicating how many times the RRC resume has been tried and has failed. The resume result information may be response type information indicating which of the RRC Resume message, the RRC Setup message, the RRC Release message, and the RRC Reject message a response message to the RRC Resume Request message transmitted by the UE 100 is.

Thus, the network 5 can recognize whether the RRC connection resume has succeeded, based on the log information (resume result information).

In the one embodiment, the UE 100 includes, in the log information, information (also referred to as “cause information”) indicating a cause that the UE 100 has performed the RRC connection resume associated with multicast reception. The UE 100 may select one of 1) a cause that reception quality at the time of multicast reception has deteriorated and 2) a cause that necessity to acquire the multicast reception configuration from the network 5 (gNB 200) has arisen, and set the cause to the cause information. 1) The cause may be subdivided into 1a) a cause that a measurement result of the reception quality has deteriorated compared to the threshold value, and 1b) a cause that a reception error of the multicast reception has occurred or the reception error has continued for a predetermined time. 2) The cause may be subdivided into 2a) a cause that the UE 100 does not have the multicast reception configuration and the UE 100 has received from the network 5 a group notification indicating activation of a multicast session that the UE 100 has already joined, and 2b) a cause that the UE 100 has performed cell reselection from the first cell to the second cell, and the second cell has not provided through a multicast MCCH a multicast reception configuration for receiving a multicast session that the UE 100 has already joined.

Thus, the network 5 can recognize the cause that the UE 100 has performed the RRC connection resume, based on the log information (cause information).

### (3.2) Specific Example of Operation

A first operation pattern and a second operation pattern will be described as a specific example of the operation of the mobile communication system 1 according to the embodiment.

### (3.2.1) First Operation Pattern

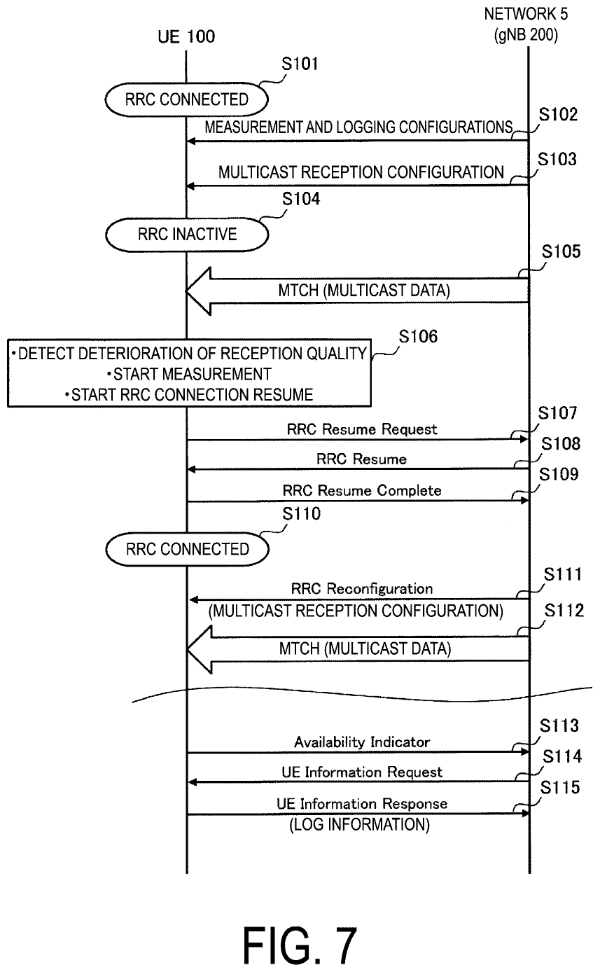

FIG. 7 is a diagram illustrating an example of the first operation pattern according to the embodiment. According to the first operation pattern, the UE 100 detects deterioration of reception quality, logs a state where an MTCH cannot be normally received, and transmits log information to the network 5.

In step S101, the UE 100 is in the RRC connected state in a cell (serving cell) of the gNB 200.

In step S102, the gNB 200 may transmit, to the UE 100, configuration information (also referred to as “measurement and logging configuration”) for configuring measurement and logging for RRC connection resume associated with multicast reception. The UE 100 may receive the measurement and logging configurations. The gNB 200 may perform the configurations using an RRC Reconfiguration message. The gNB 200 may perform the configurations using the RRC Release message. The measurement and logging configurations may include information for designating a logging target. The logging target may be at least one selected from the group consisting of elapsed time information, packet error information, resume result information, and cause information.

In step S103, the gNB 200 transmits to the UE 100 the multicast reception configuration for receiving the multicast session that the UE 100 has already joined. The gNB 200 may configure for the UE 100 the threshold value to be compared with the multicast reception quality. The UE 100 may receive the multicast reception configuration. The gNB 200 may perform the configurations using an RRC Reconfiguration message. The gNB 200 may perform the configurations using the RRC Release message.

In step S104, when the gNB 200 transmits to the UE 100 an RRC Release message including a suspend configuration, the UE 100 transitions from the RRC connected state to the RRC inactive state.

In step S105, the UE 100 in the RRC inactive state receives the multicast session from the gNB 200 based on the multicast reception configuration. More specifically, the gNB 200 transmits the multicast data on the MTCH, and the UE 100 receives the multicast data on the MTCH. The gNB 200 may configure for the UE 100 on the multicast MCCH the multicast reception configuration including the threshold value to be compared with the multicast reception quality.

In step S106, the UE 100 in the RRC inactive state detects deterioration of the multicast reception quality, starts measurement for the RRC connection resume associated with the multicast reception, and starts (triggers) the RRC connection resume. The UE 100 may detect that the reception quality (RSRP or RSRQ) of the serving cell falls below the configured threshold value (e.g., an RSRP threshold value or an RSRQ threshold value). The UE 100 may detect that the reception quality of the MTCH has deteriorated. The UE 100 may detect that a reception error has occurred (or that a reception error has continued). The UE 100 may detect that Quality of Service (QoS) of the multicast session will no longer be satisfied.

In step S107, the UE 100 in the RRC inactive state transmits an RRC Resume Request message to the gNB 200. The gNB 200 receives the RRC Resume Request message. The UE 100 may end measurement at this point of time. Note that the UE 100 may execute a random access procedure prior to transmission of the RRC Resume Request message. The random access procedure includes a step of transmitting a random access preamble from the UE 100 to the gNB 200 on a Physical Random Access CHannel (PRACH), and a step of transmitting a random access response from the gNB 200 to the UE 100.

In step S108, the gNB 200 transmits the RRC Resume message to the UE 100. The UE 100 receives the RRC Resume message. The UE 100 may end measurement at this point of time.

In step S109, the UE 100 in the RRC inactive state transmits an RRC Resume Complete message to the gNB 200. The gNB 200 receives the RRC Resume Complete message. The UE 100 may end measurement at this point of time.

In step S110, the UE 100 transitions from the RRC inactive state to the RRC connected state.

In step S111, the gNB 200 transmits to the UE 100 an RRC Reconfiguration message including a new multicast reception configuration for the RRC connected state. The UE 100 receives the RRC Reconfiguration message. The UE 100 may end measurement at this point of time.

In step S112, the UE 100 in the RRC connected state receives a multicast session from the gNB 200 based on the new multicast reception configuration. More specifically, the gNB 200 transmits the multicast data on the MTCH, and the UE 100 receives the multicast data on the MTCH. The UE 100 may end measurement at this point of time.

Note that the UE 100 may end measurement when the UE 100 is no longer interested in receiving the multicast session. For example, assuming a case where a user closes an MBS application due to a reception failure, or the like, a notification indicating that the user is no longer interested in receiving the multicast session may be notified from an upper layer (NAS or the like) to an AS layer in the UE 100. In the UE 100, the AS layer may end the measurement in response to the notification from the upper layer (the NAS or the like).

The log information obtained by the measurement includes at least one information selected from the group consisting of following 1) to 4).
1) Time from start of measurement to end of measurement (elapsed time information):
   The UE 100 may measure the time using a timer. For example, the UE 100 may activate the timer at the measurement start timing, and stop the timer at the measurement end timing. The UE 100 receives a value of the timer.
2) Packet error count (packet error information) from start of measurement to end of measurement:
   A packet error rate may be used.
3) Status of RRC resume success/failure (resume result information):
   The resume result information is information indicating whether the RRC resume has succeeded or failed. The resume result information may be information on the number of times indicating which RRC resume has succeeded. The resume result information may be information on the number of times indicating how many times the RRC resume has been tried and has failed. The resume result information may be information of a response message (an RRC Resume message in this operation example) to the RRC Resume Request message.
4) Reason (cause information) why RRC resume has been performed:
   In this operation example, deterioration of reception quality such as the fact that the reception quality has fallen below the RSRP/RSRQ threshold value is indicated as a resume reason (resume cause).

Subsequently, in step S113, the UE 100 transmits to the gNB 200 a notification (Availability Indicator) indicating that the log information is held. The gNB 200 receives the notification (Availability Indicator). For example, the UE 100 may include a notification (Availability Indicator) in the RRC Setup Complete message and transmit the notification to the gNB 200 at a time of transition from the RRC idle state to the RRC connected state. The UE 100 may include a notification (Availability Indicator) in the RRC Resume Complete message and transmit the notification to the gNB 200 at the time of transition from the RRC inactive state to the RRC connected state.

In step S114, the gNB 200 transmits, to the UE 100, a message (UE Information Request message) for requesting transmission of the log information. The UE 100 receives the message (UE Information Request message).

In step S115, the UE 100 transmits a message (a UE Information Response message or another RRC message) including the log information to the gNB 200. The gNB 200 receives the message. The gNB 200 may acquire the log information in the message, and transmit the acquired log information to the CN 20 or an Operations, Administration, and Maintenance (OAM). The network 5 may optimize various network parameters to improve multicast reception quality based on the log information.

Note that, although the RRC Resume message is transmitted from the gNB 200 to the UE 100 in step S108 in the operation example in FIG. 7, the RRC Setup message may be transmitted from the gNB 200 to the UE 100. In this case, the RRC Setup Complete message may be transmitted from the UE 100 to the gNB 200 in step S109. The UE 100 may end measurement at a time of reception of the RRC Setup message or at a time of transmission of the RRC Setup Complete message.

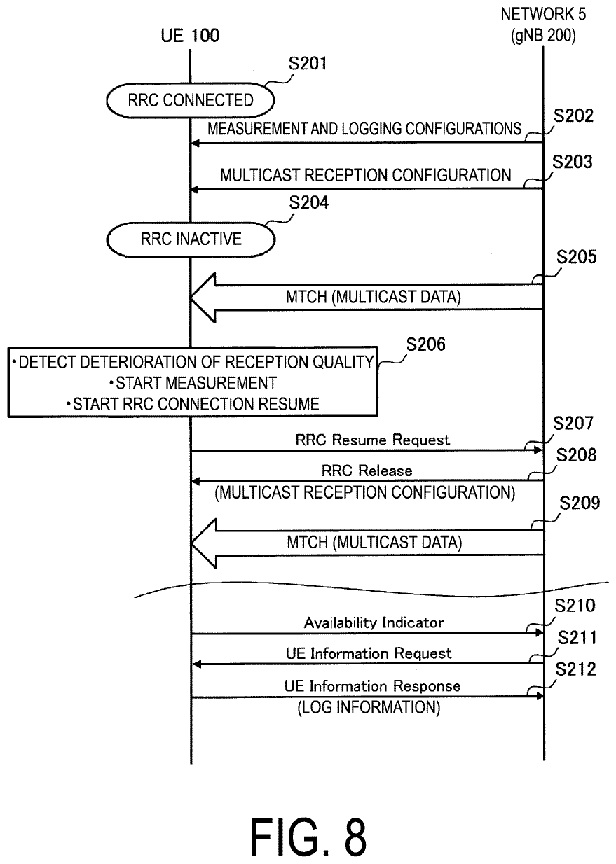

FIG. 8 is a diagram illustrating another example of the first operation pattern according to the embodiment.

The operations in steps S201 to S207 are the same as and/or similar to those in the operation example in FIG. 7.

In step S208, the gNB 200 transmits to the UE 100 an RRC Release message including the suspend configuration and the multicast reception configuration. The UE 100 receives the RRC Release message. The UE 100 may end measurement at this point of time.

The UE 100 acquires a new multicast reception configuration while maintaining the RRC inactive state in response to reception of the RRC Release message in step S208 without transitioning to the RRC connected state. In step S209, the UE 100 receives the multicast session from the gNB 200 based on the new multicast reception configuration. More specifically, the gNB 200 transmits the multicast data on the MTCH, and the UE 100 receives the multicast data on the MTCH.

The operations in steps S210 to S212 are the same as and/or similar to those in the operation example of FIG. 7.

### (3.2.2) Second Operation Pattern

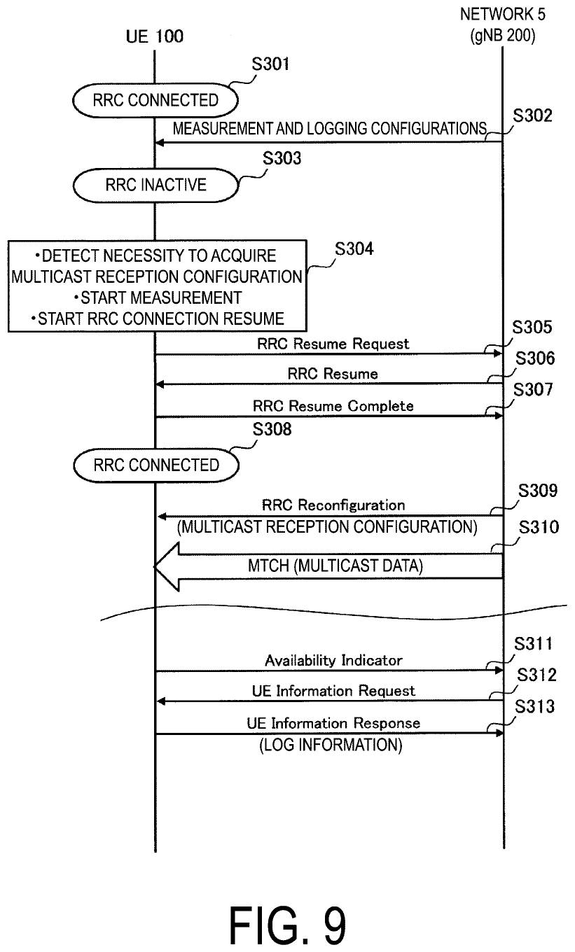

FIG. 9 is a diagram illustrating an example of the second operation pattern according to the embodiment. In the second operation pattern, the UE 100 detects that there exists no multicast reception configuration for receiving a multicast session that the UE 100 has already joined, logs a situation in which the MTCH cannot be normally received, and transmits log information to the network 5.

In step S301, the UE 100 is in the RRC connected state in the cell (serving cell) of the gNB 200.

In step S302, the gNB 200 may transmit, to the UE 100, the configuration information (also referred to as “measurement and logging configurations”) for configuring measurement and logging for RRC connection resume associated with multicast reception. The UE 100 may receive the measurement and logging configurations. The gNB 200 may perform the configurations using an RRC Reconfiguration message. The gNB 200 may perform the configurations using the RRC Release message. The measurement and logging configurations may include information for designating a logging target. The logging target may be at least one selected from the group consisting of the elapsed time information, the packet error information, the resume result information, and the cause information.

In step S303, when the gNB 200 transmits the RRC Release message including the suspend configuration to the UE 100, the UE 100 transitions from the RRC connected state to the RRC inactive state. The gNB 200 may include, in the RRC Release message, the multicast reception configuration for receiving the multicast session that the UE 100 has already joined and transmit the multicast reception configuration to the UE 100. The UE 100 may stand by for start of a multicast session or may be receiving a multicast session.

In step S304, the UE 100 detects that it is necessary to receive the multicast reception configuration from the gNB 200 because the UE 100 does not hold the PTM configuration that is valid in the RRC inactive state, starts measurement for RRC connection resume associated with multicast reception, and starts (triggers) RRC connection resume. For example, the UE 100 may perform the detection by receiving a group notification or performing cell reselection. Such a situation may be a situation in which a multicast reception configuration is not provided through a multicast MCCH. Specifically, the multicast MCCH may not be broadcast in the serving cell. The multicast MCCH may be broadcast, but may not include the multicast reception configuration of the multicast session that the UE 100 has already joined.

The operations in steps S305 to S313 are the same as and/or similar to those in the operation example of FIG. 7. However, in the log information in the present operation example, the cause information indicating the reason why the RRC resume has been performed may be a reason (cause) why it is necessary to acquire the multicast reception configuration.

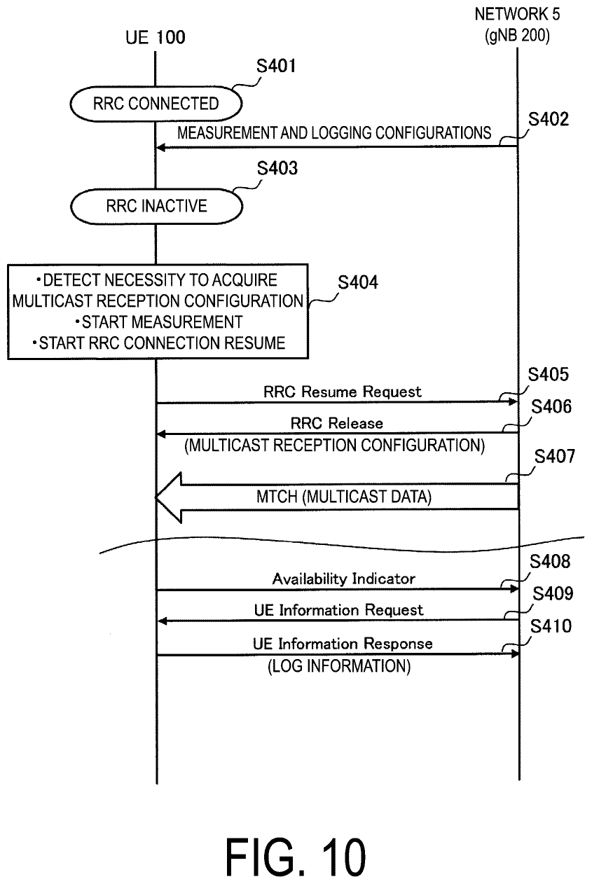

FIG. 10 is a diagram illustrating another example of the second operation pattern according to the embodiment.

The operations in steps S401 to step S405 are the same as and/or similar to those in the operation example of FIG. 9.

In step S406, the gNB 200 transmits the RRC Release message including the suspend configuration and the multicast reception configuration to the UE 100. The UE 100 receives the RRC Release message. The UE 100 may end measurement at this point of time.

The UE 100 acquires a new multicast reception configuration while maintaining the RRC inactive state in response to reception of the RRC Release message in step S406 without transitioning to the RRC connected state. In step S407, the UE 100 receives a multicast session from the gNB 200 based on the new multicast reception configuration. More specifically, the gNB 200 transmits the multicast data on the MTCH, and the UE 100 receives the multicast data on the MTCH.

The operations in steps S408 to S410 are the same as and/or similar to those in the operation example of FIG. 9.

### (4) Other Embodiments

Although the multicast reception in the RRC inactive state has been mainly described in the above-described embodiment, the operations according to the above-described embodiment may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps do not need to be necessarily executed, and only some of the steps may be executed. The order between the steps in each flow may be changed as appropriate.

Although the example in which the base station is an NR base station (gNB) has been described in the embodiment and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include a Network Controlled Repeater (NCR)-MT and a Reconfigurable Intelligent Surface (RIS)-MT in addition to the IAB-MT.

The term “network node” mainly means a base station, but may also mean a core network apparatus or a part (a CU, a DU, or an RU) of the base station. The network node may include a combination of at least a part of the core network apparatus and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be configured as a semiconductor integrated circuit (a chipset or a System on a chip (SoC)).

The functions implemented by the UE 100 or the gNB 200 (the network node) may be implemented in a circuitry or a processing circuitry programmed to implement the described functions, and including a general-purpose processor, a special-purpose processor, an integrated circuit, Application Specific Integrated Circuits (ASICs), a Central Processing Unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, and means are hardware programmed to implement, or hardware performing, the described functions. The hardware may be any hardware disclosed herein or any hardware programmed to implement or known to execute the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. Similarly, the phrase “depending on/in response to” means both “only depending on/in response to” and “at least partially depending on/in response to”. The terms “include” and “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure.

### (5) Supplements

Features relating to the embodiment described above are described below as supplementary notes.

### Supplementary Note 1

A communication method executed in a mobile communication system for providing a Multicast Broadcast Service (MBS), the communication method including:
starting, by a user equipment in a Radio Resource Control (RRC) inactive state, RRC connection resume in association with a multicast session that the user equipment has already joined;
starting, by the user equipment, measurement relating to the RRC connection resume at a first timing at which a start event for the RRC connection resume has occurred;
ending, by the user equipment, the measurement at a second timing at which an end event for the RRC connection resume has occurred; and
by the user equipment, storing log information indicating a result of the measurement and then transmitting the log information to a network.

### Supplementary Note 2

The communication method according to Supplementary Note 1, wherein the start event is a first event indicating that reception quality from the network at a time of multicast reception has deteriorated.

### Supplementary Note 3

The communication method according to Supplementary Note 2, wherein the first event indicates that a measurement result of the reception quality is worse than a threshold value.

### Supplementary Note 4

The communication method according to Supplementary Note 2, wherein the first event indicates that a reception error of the multicast reception has occurred or that the reception error has continued for a predetermined time.

### Supplementary Note 5

The communication method according to Supplementary Note 1, wherein the start event is a second event indicating that necessity to acquire from the network a multicast reception configuration for receiving the multicast session has arisen.

### Supplementary Note 6

The communication method according to Supplementary Note 5, wherein the second event is, when the user equipment does not have the multicast reception configuration, having received, by the user equipment from the network, a group notification indicating activation of the multicast session.

### Supplementary Note 7

The communication method according to Supplementary Note 5, wherein the second event is, when the user equipment has performed cell reselection from a first cell to a second cell, not providing, by the second cell, the multicast reception configuration through a multicast MCCH.

### Supplementary Note 8

The communication method according to any one of Supplementary Notes 1 to 7, wherein the end event is an event indicating that the user equipment has transmitted to the network an RRC Resume Request message or an RRC Resume Complete message.

### Supplementary Note 9

The communication method according to any one of Supplementary Notes 1 to 7, wherein the end event is an event indicating that the user equipment has received from the network an RRC Resume message, an RRC Setup message, an RRC Release message, or an RRC Reject message.

### Supplementary Note 10

The communication method according to any one of Supplementary Notes 1 to 7, wherein the end event is an event indicating that the user equipment has received from the network an RRC reconfiguration message including a multicast reception configuration for receiving the multicast session after the user equipment has transitioned to an RRC connected state, or an event indicating that the user equipment has started receiving multicast data using the multicast reception configuration.

### Supplementary Note 11

The communication method according to any one of Supplementary Notes 1 to 10, wherein the user equipment is configured to include, in the log information, information indicating an elapsed time from the first timing to the second timing.

### Supplementary Note 12

The communication method according to any one of Supplementary Notes 1 to 11, wherein the user equipment is configured to include, in the log information, information indicating a packet error count or a packet error rate of multicast reception from the first timing to the second timing.

### Supplementary Note 13

The communication method according to any one of Supplementary Notes 1 to 12, wherein the user equipment is configured to include, in the log information, information relating to whether the RRC connection resume has succeeded.

### Supplementary Note 14

The communication method according to any one of Supplementary Notes 1 to 13, wherein the user equipment is configured to include, in the log information, information indicating a cause for the RRC connection resume that the user equipment has performed.

### Supplementary Note 15

A user equipment used in a mobile communication system for providing a Multicast Broadcast Service (MBS), the user equipment including:
a controller configured to execute
processing of starting, in a Radio Resource Control (RRC) inactive state, RRC connection resume in association with a multicast session that the user equipment has already joined,
processing of starting measurement relating to the RRC connection resume at a first timing at which a start event for the RRC connection resume has occurred,
processing of ending the measurement at a second timing at which an end event for the RRC connection resume has occurred, and
processing of storing log information indicating a result of the measurement and then transmitting the log information to a network.

### Supplementary Note 16

A network node used in a mobile communication system for providing a Multicast Broadcast Service (MBS), the network node including:
a controller configured to acquire, from a user equipment, log information indicating a result of measurement relating to RRC connection resume from a first timing at which a start event for the RRC connection resume associated with a multicast session that the user equipment has already joined has occurred to a second timing at which an end event for the RRC connection resume has occurred.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method executed in a mobile communication system for providing a Multicast Broadcast Service (MBS), the communication method comprising:
starting, by a user equipment in a Radio Resource Control (RRC) inactive state, RRC connection resume in association with a multicast session that the user equipment has already joined;
starting, by the user equipment, measurement relating to the RRC connection resume at a first timing at which a start event for the RRC connection resume has occurred;
ending, by the user equipment, the measurement at a second timing at which an end event for the RRC connection resume has occurred; and
by the user equipment, storing log information indicating a result of the measurement and then transmitting the log information to a network.

2. The communication method according to claim 1, wherein the start event is a first event indicating that reception quality from the network at a time of multicast reception has deteriorated.

3. The communication method according to claim 2, wherein the first event indicates that a measurement result of the reception quality is worse than a threshold value.

4. The communication method according to claim 2, wherein the first event indicates that a reception error of the multicast reception has occurred or that the reception error has continued for a predetermined time.

5. The communication method according to claim 1, wherein the start event is a second event indicating that necessity to acquire from the network a multicast reception configuration for receiving the multicast session has arisen.

6. The communication method according to claim 5, wherein the second event is, when the user equipment does not comprise the multicast reception configuration, having received, by the user equipment from the network, a group notification indicating activation of the multicast session.

7. The communication method according to claim 5, wherein the second event is, when the user equipment has performed cell reselection from a first cell to a second cell, not providing, by the second cell, the multicast reception configuration through a multicast MCCH.

8. The communication method according to claim 1, wherein the end event is an event indicating that the user equipment has transmitted to the network an RRC Resume Request message or an RRC Resume Complete message.

9. The communication method according to claim 1, wherein the end event is an event indicating that the user equipment has received from the network an RRC Resume message, an RRC Setup message, an RRC Release message, or an RRC Reject message.

10. The communication method according to claim 1, wherein the end event is an event indicating that the user equipment has received from the network an RRC reconfiguration message comprising a multicast reception configuration for receiving the multicast session after the user equipment has transitioned to an RRC connected state, or an event indicating that the user equipment has started receiving multicast data by using the multicast reception configuration.

11. The communication method according to claim 1, wherein the user equipment is configured to comprise, in the log information, information indicating an elapsed time from the first timing to the second timing.

12. The communication method according to claim 1, wherein the user equipment is configured to comprise, in the log information, information indicating a packet error count or a packet error rate of multicast reception from the first timing to the second timing.

13. The communication method according to claim 1, wherein the user equipment is configured to comprise, in the log information, information relating to whether the RRC connection resume has succeeded.

14. The communication method according to claim 1, wherein the user equipment is configured to comprise, in the log information, information indicating a cause for the RRC connection resume that the user equipment has performed.

15. A user equipment used in a mobile communication system for providing a Multicast Broadcast Service (MBS), the user equipment comprising:
a controller configured to execute
processing of starting, in a Radio Resource Control (RRC) inactive state, RRC connection resume in association with a multicast session that the user equipment has already joined;
processing of starting measurement relating to the RRC connection resume at a first timing at which a start event for the RRC connection resume has occurred;
processing of ending the measurement at a second timing at which an end event for the RRC connection resume has occurred; and
processing of storing log information indicating a result of the measurement and then transmitting the log information to a network.

16. A network node used in a mobile communication system for providing a Multicast Broadcast Service (MBS), the network node comprising a controller configured to acquire, from a user equipment, log information indicating a result of measurement relating to RRC connection resume from a first timing at which a start event for the RRC connection resume associated with a multicast session that the user equipment has already joined has occurred to a second timing at which an end event for the RRC connection resume has occurred.
